(19) United States
(12) Patent Application Publication
(10) Pub. No.: US 2008/0257979 A1
(43) Pub. Date: Oct. 23, 2008

(54) PLURAL COMPONENT PURGING SYSTEM

(76) Inventor: Robert G. Crawford, Brownsburg, IN (US)

Correspondence Address: INDIANAPOLIS OFFICE 27879;BRINKS HOFER GILSON & LIONE, ONE INDIANA SQUARE, SUITE 1600, INDIANAPOLIS, IN, 46204-2033, US

(21) Appl. No.: 11/738,715

(22) Filed: Apr. 23, 2007

(51) Int. Cl. B05B 12/10

(52) U.S. Cl. 239/75

(57) ABSTRACT

A dispensing system for settable liquids, such as urethane foams and coatings, catalyzed polyesters and epoxies, and other liquid compositions that cure or react and thicken or solidify, applies a flow of compressed air to purge the settable liquids from a mixing and dispensing apparatus, and a purge air control delays the application of compressed purge air to the dispenser for settable liquids to avoid disturbance of the dispensed settable liquid.

### FIELD OF THE INVENTION

This invention relates to systems and apparatus for dispensing settable liquids, including plural component materials, such as urethane foams and coatings, catalyzed polyesters, catalyzed epoxies and other chemical compositions that cure or react to form coatings, bodies of insulating material and reinforced plastic structures.

### BACKGROUND

Polyurethane foam systems, one example of settable liquids, usually include component A, an isocyanate, and component B, a preformulated compound comprising a polyether resin, a catalyst, a surfactant and a blowing agent. Each component of the plural component material is, by itself, generally stable, that is, each component does not cure or cross-link for several months or more, provided it is properly stored. However, mixing of component A and component B in proper concentrations initiates a chemical reaction that causes the components to begin to polymerize and generate heat which volatilizes the blowing agent and causes the polyurethane to foam, cure and cross-link. In one polyurethane system, water is used to combine with isocyanate to provide a carbon dioxide blowing agent; and in another polyurethane system, a fluorocarbon or freon, which boils at about room temperature, provides the blowing agent. In this system, the blowing agent is trapped in the resin and acts in cooperation with the other constituents of the system to foam the polyurethane. Other systems may be such that the blowing agent is used to provide a cellular structure.

Cross-linking and curing of some plural component materials can be substantially completed in a matter of seconds. To reduce the exposure of a dispensing apparatus to clogging by the settable liquid, it is desirable to mix the components in the dispensing device as close as is possible to the orifice from which the settable liquid is ejected, that is, mixing of the several components of the compound should take place substantially contemporaneously with dispensing. Mixing the components of the plural component material within the dispensing device requires the residue of the mixed components to be purged from a mixing chamber and the orifice of the dispensing device so that the residue components do not chemically react and clog the chamber and the orifice, or in any other way prevent or inhibit dispensing of the plural component material.

One example of such a dispensing device is the Probler P2 Dispenser Gun, sold by GlasCraft, Inc. of Indianapolis, Ind., an embodiment of which is shown in U.S. Pat. No. 6,697,461. In the Probler P2 gun of GlasCraft, a dispensing portion includes a movable mixing and dispensing element that forms, in combination with a pair of connection blocks carried by the gun housing, the valves that control the mixing and dispensing of the plural component material. The connection blocks are connectable with the separate pressurized sources of the components of the plural component material and include outlet openings and carry seal members around the outlet openings that interface with and seal against the sides of the mixing and dispensing element. The movable mixing and dispensing element includes an internal mixing chamber between its sides, a pair of admission openings, one between each side of the mixing and dispensing element and its internal mixing chamber, and a forward-most dispensing orifice connected with the mixing chamber. When the mixing and dispensing orifice is in its rearward position, the admission openings on each of its sides are aligned with the outlet openings of the connection blocks so the components of the plural component material can flow from their separate pressurized sources into the mixing chamber, where they are mixed and urged out of the dispensing orifice. When the mixing and dispensing element is in its forward position, the outlet openings of the connection blocks are blocked by the sides of the mixing and dispensing element, terminating the dispensation of mixed plural component materials. In the rearward position, the seals carried by the connection blocks confine the flows of the plural components to between the connection block-outlet openings and the admission openings of the mixing and dispensing element, and in the forward position, the seals prevent the plural components from flowing into the interface between the mixing and dispensing element and the connection blocks.

In the Probler P2 gun a liquid control portion includes an air-operated piston/cylinder that is connected to the mixing and dispensing element to move it between its forward and rearward positions. A trigger on the handle of the hand gun controls the application of compressed air, through a four-way valve, to the portions of the cylinder on each side of a piston to move it forwardly and rearwardly within the cylinder, thus moving the mixing and dispensing element between its rearward mixing and dispensing position and its forward position at which the flow of plural component material is terminated and the mixing chamber is purged by a flow of compressed air.

In such dispensing systems and apparatus, the flow of compressed purge air from the dispensing orifice of the dispensing gun commences immediately after the operator of the dispensing gun releases the trigger to terminate the flow of settable liquid from the dispensing gun, and the flow of compressed purge air from the dispensing orifice can damage or interfere with the desired results of the application of settable liquid. For example, if the dispensing system is being used to inject urethane foams material into a confined space, for example, the space between the exterior housing and interior liner of a refrigerator, the flow of compressed purge air from the dispensing orifice can blow the injected and still fluid urethane foam material from within the confined space where it is desired for thermal insulation. In addition, where the dispensing system is being used to form a deposited film, the flow of compressed purge air can cause non-uniformities and other flaws in the deposited film.

### BRIEF SUMMARY OF THE INVENTION

The invention provides a dispensing system for settable liquids that provides, upon cessation of dispensing, an application of compressed air, after a time delay, to remove settable liquids from the liquid dispenser.

A dispensing system of the invention includes a dispensing nozzle with a dispensing outlet and a liquid inlet for a settable liquid, liquid control for controlling the flow of settable liquid through the dispensing nozzle, including means for generating a purge control signal for a purge air control, and a purge air portion for directing a flow of compressed air through the dispensing nozzle; and a purge air control including a compressed air inlet, a purge air outlet, an input for a purge control signal, a purge air control valve connected between the compressed air inlet and the purge air outlet and a purge air delay timer, in which the purge air control reacts to a purge control signal to close the purge air control valve and activate the purge air control timer, which opens the purge air control valve after its time delay. The purge air delay timer preferably provides an adjustable delay time.

In one preferred dispensing system, the liquid control uses compressed air for operating a liquid flow control valve and for providing a purge control signal to the purge air control. Such a dispensing apparatus can include a compressed air operable piston/cylinder actuator for a liquid control valve, a user operable trigger and compressed air passageways to control a flow of compressed air for the piston/cylinder actuator and the purge control signal.

Other features and advantages of the invention will be apparent to those skilled in the art from the drawings and farther description of the invention that follows.

### BRIEF DESCRIPTION OF THE DRAWINGS

FIG. 1 is a simplified block diagram of a dispensing system of the invention;

FIG. 2 is a cross-sectional view of one dispenser apparatus usable in the invention, taken at the vertical plane and in the direction indicated by line 2-2 of FIG. 3, in the non-dispensing position;

FIG. 3 is a view of the dispenser apparatus of FIG. 2, taken from the rear;

FIG. 4 is a partial cross-sectional view of dispenser apparatus of FIGS. 2 and 3, taken at the vertical plane and in the direction indicated by line 4-4 of FIG. 3, to illustrate the mixing and dispensing element and its air-operated actuator in the dispensing position;

FIG. 5 is an enlarged partial cross-sectional view of FIG. 4 taken at the vertical plane and in the direction indicated by line 5-5 of FIG. 4 to illustrate the sealed interface between the mixing and dispensing element and its connection blocks in the mixing and dispensing position; and

FIG. 6 is a perspective view of one embodiment of a dispenser apparatus and one embodiment of a purge air control and their interconnection.

### DETAILED DESCRIPTION OF THE CURRENTLY BEST KNOWN MODE OF THE INVENTION

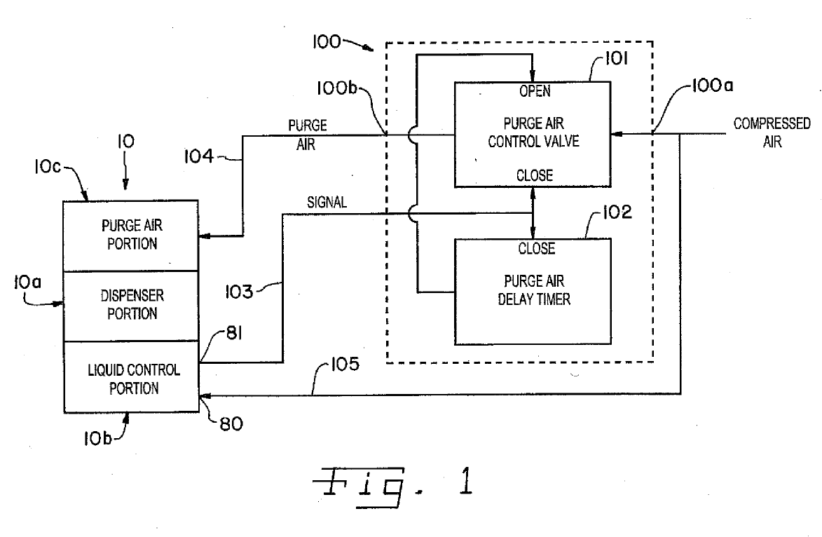

FIG. 1 is a simplified block diagram of a system and apparatus of the invention. The system includes a dispenser apparatus 10 including a dispensing portion 10a, a liquid control portion 10b and a purge air portion 10c, and a purge air control 100, including a purge air control valve 101 between a compressed air inlet 100a and a purge air outlet 100b, and a purge air delay timer 102. The liquid control portion 10b of the dispenser apparatus 10b includes means for generating a purge control signal 103 which is applied to the purge air control 100. In a preferred system and apparatus of the invention, the purge control signal 103 is generated whenever the settable liquid is being dispensed. The purge air control 100 reacts to the purge control signal 103 to close the purge air control valve 101 whenever liquid is being dispensed from the dispenser portion 10a of the dispenser apparatus 10 and sets the purge air delay timer 102, which begins its delay time sequence after the purge control signal terminates and generates an output 102a after its time delay, which opens the purge air control valve 101 and permits compressed purge air 104 to flow from the compressed air inlet 100a, through the purge air control valve 101, and the purge air outlet 100b of the purge air control 100 to the purge air portion 10c of the dispenser apparatus 10, where it is directed through the dispensing portion 10a of the dispenser apparatus 10, thereby removing settable material from the dispensing apparatus 10, preventing settable material from clogging or inhibiting the further dispensation of the settable liquid and preventing the compressed purge air leaving the dispensing portion 10a from disturbing the settable liquid that was previously emitted from the dispenser apparatus 10. Preferably, the purge air delay timer permits dispenser operating personnel to adjust the time delay between the cessation of dispensing and the initiation of purge air, which may be important if the dispenser apparatus 10 is to be used with various settable liquids which may thicken or set at different times after mixing or exposure to dispensing activities. For most plural component materials and applications time delays of 2-3 seconds are adequate, but time delays as long as one minute, or more, may be used with settable liquids that do not react or cure quickly.

As shown in FIG. 1, compressed air 105 may be applied to the liquid control portion 10b of the dispenser apparatus 10 to assist in controlling the flow of the settable liquid from the dispenser apparatus and to provide a purge control signal. Where the dispenser apparatus 10 uses compressed air in the liquid control portion, the purge control signal 103 may comprise compressed air to operate the purge air control valve 101 and purge air delay timer 102, as further described below.

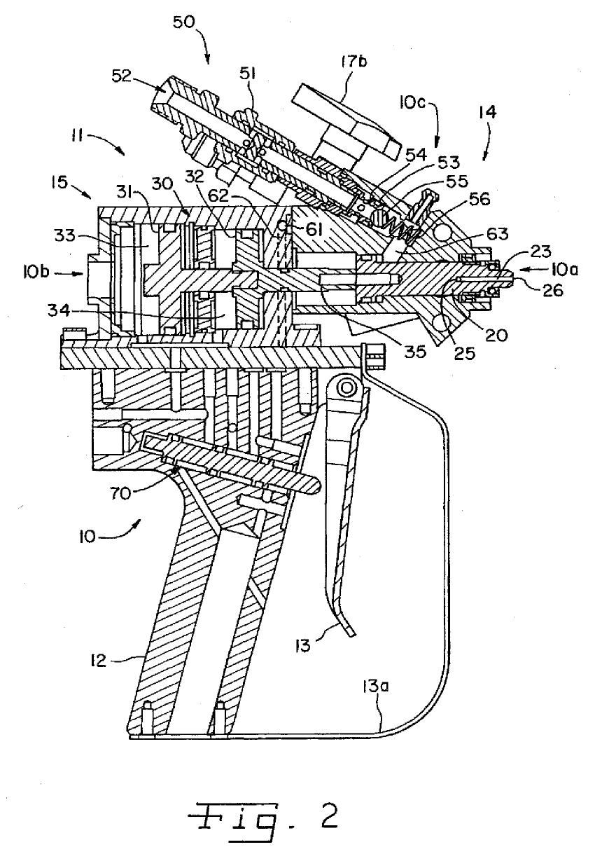

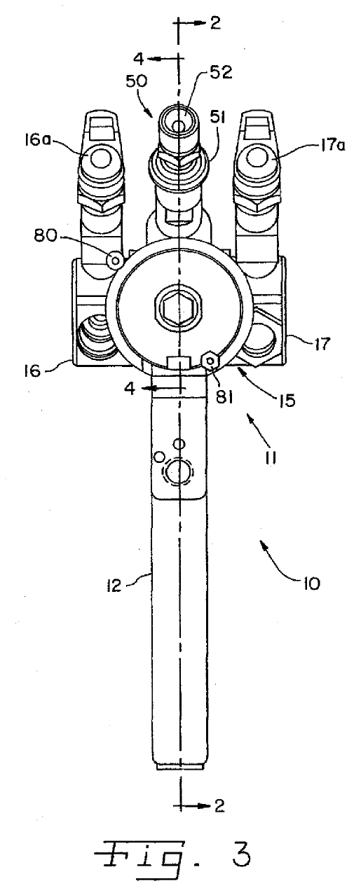

FIGS. 2-5 exemplify one preferred dispensing gun 10 for plural component settable materials, such as urethane foam materials, that may be used in the invention. As indicated by FIG. 1, the dispensing gun 10 includes a housing 11, a handle 12 extending from the housing at an angle, and a trigger 13 pivotally carried by the handle 12. The gun 10 may be conveniently provided with a trigger guard 13a. The housing 11 includes a connection portion 14 at its forward end and an actuator portion 15 at its rearward end. The words “forward” and “forwardly” in this description refer to the direction in which mixed plural component material is dispensed, and the terms “rearward” and “rearwardly” refer to the direction toward the back of the gun, which is illustrated in FIG. 3.

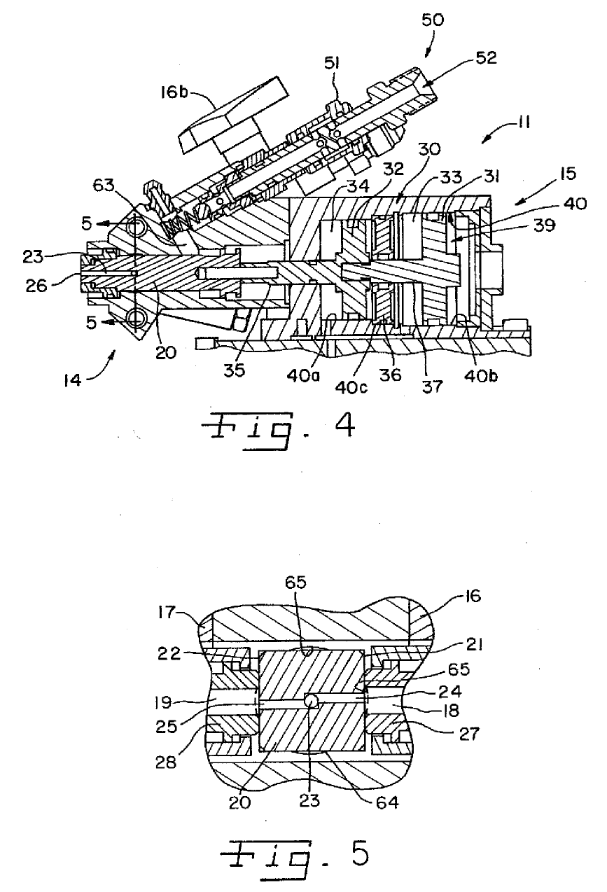

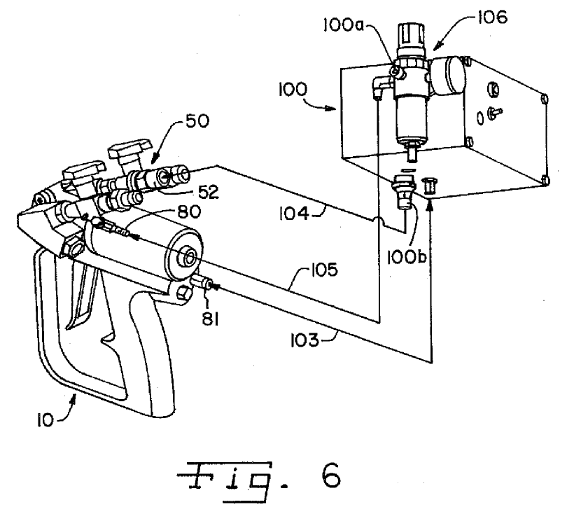

The connection portion of the housing 14 carries a pair of connection blocks 16 and 17 (see FIG. 3). The connection blocks 16 and 17 provide connections for hoses that lead from the apparatus 10 to pressurized sources of each of the components of the plural component material. For example, connection block 16 carries a hose connection 16a for a flexible hose leading to a source of component A of a plural component settable liquid, and connection block 17 carries a hose connection 17a for a flexible hose leading to a source of component B of the plural component settable liquid. The connection blocks 16 and 17 can also carry valves 16b and 17b to block the flow of the plural components to the outlets 18, 19 (FIG. 5) of the connection blocks. The connection blocks 16 and 17 thus provide the inlets for each of the components of the plural component settable liquid to the hand gun 10, and are also sometimes referred to in this description as inlet blocks 16 and 17.

In the gun 10, the hose connections 16a and 17a project upwardly and rearwardly from the connection blocks 16 and 17 so the hoses supplying the plural components from the respective separate sources of supply will be conveniently carried by the hand gun 10 over the handle 12. The hand gun 10 is likewise connectable with a source of compressed air by a control air inlet means 80 and with a source of compressed purge air by a purge air inlet means 50. As illustrated by FIGS. 2 and 4, the purge air inlet means 50 also projects upwardly and rearwardly from the connection portion 14 of the housing so that an air hose connected thereto will be conveniently carried over the handle 12 of the gun. The purge air inlet means 50 can include a sliding on/off valve 51 so that the apparatus operator can shut off the flow of purge air from the gun when it is not needed. An on/off valve in the purge air control 100 (not shown) can also be used to control the flow of compressed air 105 used to control the flow of liquid when the gun is not in operation.

As best illustrated in FIG. 2, the connector portion 14 of the housing provides a dispensing portion 10a and slidably carries a mixing and dispensing element 20, and the actuator portion 15 of the housing 11 carries air actuator 30 to move the mixing and dispensing element 20 forwardly and rearwardly within the dispenser portion 10a of the connection portion 14 of the housing.

As illustrated best by FIG. 5, the mixing and dispensing element 20 is formed with a pair of planar sides 21 and 22, an internal mixing chamber 23 located between the planar sides 21 and 22, and a pair of admission openings 24 and 25, with admission opening 24 extending between planar sidewall 21 and the mixing chamber 23, and with admission opening 25 extending between planar sidewall 22 and the mixing chamber 23. As best illustrated in FIG. 2, the mixing chamber 23 extends forwardly through the mixing and dispensing element 20 from the admission openings 24, 25 to a dispensing orifice 26. Again, as illustrated by PIG. 5, the connection or inlet blocks 16 or 17 include outlet openings 18 and 19, respectively, that are at the terminal ends of liquid passageways extending through the connection or inlet blocks 16 or 17, respectively, from their respective hose connections 16a and 17a. A pair of seal elements 27, 28 are carried by the collection blocks 16 and 17 around their outlet openings 18 and 19, respectively, to seal the interfaces between the planar sides 21 and 22 of the mixing and dispensing element 20 and the adjoining side surfaces of the connection/inlet blocks 16 and 17.

As illustrated by FIGS. 4 and 5, when the air actuator 30 moves the mixing and dispensing element 20 rearwardly, it comes to rest in a dispensing position in which the admission openings 24, 25 of the mixing and dispensing element 20 are aligned with the outlets 18, 19 of the connection blocks 16, 17, and the pressurized sources of the components of the plural component settable material can urge the components of the plural component settable material, which are connected to the hose connections 16a and 17a, through the admission openings 24 and 25 into the mixing chamber 23 for mixing and dispensation from the dispensing orifice 26 of the mixing and dispensing element 20.

When the air actuator 30 moves the mixing and dispensing element 20 forwardly within the connection portion 14 of the housing 11, the admission openings 24, 25 of the mixing and dispensing element 20 are moved out of alignment with the outlet openings 18, 19 of the connection blocks 16, 17, and the planar sides 21, 22 of the mixing and dispensing element 20 block the outlet openings 18, 19, which are sealed shut by the planar sides 21, 22 of the mixing and dispensing element 20 and the seal elements 27, 28. Thus, the mixing and dispensing element 20 not only provides a means for mixing and dispensing plural component materials, it also provides a valve means for controlling their flow from the hand gun 10.

The dispenser apparatus 10 employs compressed air in the liquid control portion 10b, including actuator portion 15, to control the mixing and dispensing of the plural components of the settable liquid. Compressed air 105 is delivered to the dispenser apparatus 10 through a compressed control air inlet 80 (FIG. 3) and directed through the compressed air passageway 61 in the actuator portion 15 of the housing 11 for connection with air passageways in the handle 12, and for control by a four-way valve 70 (FIG. 2), which is operated by the trigger 13 pivotally connected with the handle. When the trigger 13 is in the unpulled position, the chambers of the four-way valve 70 connect compressed air from passageway 61 to the air actuator 30 to force the mixing and dispensing element 20 forwardly to the non-dispensing position illustrated in FIG. 2, and when the trigger 13 is pulled rearwardly by an apparatus operator, the chambers of the four-way valve apply compressed air to the air actuator 30 to move the mixing and dispensing element 20 to its rearward dispensing position illustrated in FIGS. 4 and 5. The passageways leading from the four-way valve through the handle 12 and the actuator portion 15 of the housing to the air actuator 30 are not shown but will be apparent to those skilled in the art from the description of the air actuator.

As indicated above, the control portion 10b of a dispenser apparatus includes means for generating a purge control signal 103 for the purge air control. In dispensing apparatus 10, such as that illustrated in FIGS. 2-5, that use compressed air to assist operation of the liquid control valve components 20, 21, 22, 24, 25, 27, 28 of the dispensing gun 10, a passageway (not shown) in the dispensing gun 10 can direct compressed air that moves the pistons 31 and 32 of the piston/cylinder actuator 30 rearwardly to the dispensing position to a signal output 81 at the rear of the dispensing apparatus (FIG. 3) to provide a purge control signal 103 for the purge air control 100 whenever the trigger 13 is pulled.

In a preferred purge air control 100 for use with dispensing apparatus such as that illustrated by FIGS. 2-5 and described herein, the compressed air purge control signal 103 is applied to one side of an air-operated, two position purge air control valve 101 to close the purge air control valve 101 and block the flow of purge air from the compressed air inlet 100a to the purge air outlet 100b, and its application to the dispensing apparatus 10 whenever the settable liquid is being dispensed. As illustrated in FIG. 1, the compressed air signal 103 is also applied to the purge air delay timer 102 to close the purge air control timer output valve. When the trigger is released, the compressed air purge control signal terminates, the output valve of the purge air delay timer 102 remains closed, and the purge air delay timer 102 initiates its timing cycle. At the end of the timing cycle of the purge air delay timer 102, the purge air delay timer output valve opens and a compressed air output 102a is applied to the purge air control valve 101 that opens the purge air control valve 101, permitting a flow of compressed air from the compressed air inlet 100a and out of the purge air outlet 100b to provide a flow of purge air 104 into a purge air inlet means 50 of the dispenser apparatus through the purge air portion 10a and mixing and dispensing element 20 of the dispenser apparatus 10. Purge air will continue to flow, unless turned off by manual valve 51, until dispensing is initiated by the equipment operator.

An example of a commercial valve that can be used as a purge air control valve in the invention is one manufactured by Norgren of Littleton, Colo., their part number 150-03-011-03, and an example of a commercial delay timer that can be used in the invention is one manufactured by Clippard, USA of Cincinnati, Ohio, their part number R343.

Where compressed air is not used to control the flow of settable liquids from the dispenser apparatus 10, other means can be used to provide a purge control signal for the purge air control 100. For example, a small proximity sensor, electrical switch or other such electrical element can be used to detect the operation of the trigger 13 and generate an electric purge control signal 103 for application to and operation of electrically-operated valves and timers in the purge air control 100.

With the dispenser apparatus illustrated in FIGS. 2-5, compressed purge air 104 is directed to purge air portion 10c. Compressed purge air 104 is admitted to the inlet 52 of the purge air inlet means 50, and is directed from the purge air inlet means 50 through passageways, including passageway 63 formed in the dispenser portion 10a, including connector portion 14 of housing 11 to an air chamber 64 (shown in FIG. 5), formed by a cylindrical cavity portion 65 within the connector portion 14 of the dispenser 10 in communication with the sides 21, 22 of the mixing and dispensing element 20, which has a square cross-section in the preferred embodiment. When the mixing and dispensing element 20 is in its forward non-dispensing position, the admission openings 24, 25 of the mixing and dispensing element 20 are moved from within seal elements 27, 28 and are located within the air chamber 64 so that compressed air applied to the air chamber 64 will be forced through the admission openings 24, 25, the mixing chamber 23, and the dispensing orifice 26, expelling residue of the plural component material therefrom so it does not cure and prevent or inhibit further operation of the gun 10. The flow of purging air through passageway 63, the air chamber 64 formed in connection portion 14 of the housing, the admission openings 24, 25 and the mixing chamber 23 and dispensing orifice 26 may be further controlled by the on/off valve 51, or another valve in the purge air control 100.

FIG. 6 illustrates a dispenser gun 10 and its connection to a purge air control 100. As well-known in the art, the dispenser gun 10 and purge air control 100 can be connected by a hose cable, which can include the flexible compressed air hoses for a purge control signal and purge air, indicated by 103 and 104, and compressed air to operate the piston/cylinder activator in the dispenser apparatus, indicated by 105. As also well-known in the art, the purge air control can include pressure regulators, manual on-off valves and other elements usable to conveniently control the compressed air delivered to the dispenser apparatus for its operation. For example, the compressed air inlet 100a illustrated in FIG. 6 introduces compressed air for use in the dispenser apparatus into a filter/moisture separator/pressure regulator element 106.

The foregoing detailed description and drawings should be regarded as illustrative, rather than limiting, and it should be understood that it is the following claims, including all equivalents, that are intended to define the spirit and scope of this invention.

What is claimed is:

1. A dispensing system for settable liquids, comprising:
a dispensing nozzle for the settable liquid including a dispensing outlet and a liquid outlet; a liquid control for controlling the flow of settable liquid through the dispensing nozzle, including means for generating a purge control signal for a purge air control; and a purge air portion for directing a flow of compressed purge air through the dispensing nozzle; and
a purge air control including a compressed air inlet, a purge air outlet, a purge control signal input, a purge air control valve connected between the compressed air inlet and purge air outlet, and a purge air delay timer, said purge air control reacting to said purge control signal to close the purge air control valve until said purge air control valve is opened by said purge air delay timer.

2. The dispensing system of claim 1, wherein the liquid control for controlling the flow of settable liquids uses compressed air to assist operator personnel.

3. The dispensing system of claim 2, wherein the liquid control includes a compressed air operable piston/cylinder actuator for operation of a liquid flow control valve, and a trigger operable by the operator personnel to control the flow of compressed air to the piston/cylinder actuator.

4. The dispensing system of claim 3, wherein the means for generating a purge control signal for the purge air control comprises a compressed air passageway connected with the compressed air used to operate the piston/cylinder actuator.

5. A dispensing system for settable liquids, comprising:
a liquid dispenser for the settable liquid including a dispensing nozzle for the settable liquid and at least one liquid inlet opening to the dispensing nozzle, a liquid control valve, a liquid control portion for use of compressed air to operate said liquid control valve and control the flow of settable liquid from the dispensing nozzle, and a purge air portion for directing a flow of purge air through the at least one liquid inlet opening and the dispensing nozzle,
said liquid control portion including a compressed air inlet, a compressed air operable piston/cylinder actuator for said liquid control valve, at least one compressed air passageway for directing a flow of compressed air to said piston/cylinder actuator, a user operable control air valve in said at least one passageway to control the flow of compressed air to said piston/cylinder actuator, and a signal air output for the emission of signal air from said piston/cylinder actuator,
said purge air portion including a purge air inlet, and at least one compressed air passageway to direct purge air from said purge air inlet to and through said liquid inlet opening and said dispensing nozzle; and
a purge air control including a compressed air inlet, and a signal air inlet connected with said signal air outlet of said liquid control portion, a purge air delay timer and a purge air control valve, the application of said signal air closing the purge air control valve preventing the flow of purge air, and setting the purge air delay timer, the termination of signal air commencing the delay period of the purge air delay timer, the purge air delay timer opening the purge air control valve at the end of the delay period.

6. The dispensing system of claim 5 wherein said signal air is generated by said liquid control portion whenever said user operable control air valve is operated by a user.

7. The dispensing system of claim 5 wherein said purge air control valve is a two-position valve closed by the application of signal air and opened by the application of compressed air from said purge air control timer after the delay period.

8. A dispensing system for settable liquids comprising a dispensing apparatus and a purge air control:
a housing including a connection portion at its forward end and an actuator portion at its rearward end;
a mixing and dispensing element formed with opposed planar side portions, a mixing chamber within the element between the planar side portions, a pair of admission openings, one admission opening extending between each of the planar side portions and the mixing chamber, and a dispensing orifice in communication with the mixing chamber at the forward end of the mixing and dispensing element, said mixing and dispensing element being slidably carried by the connection portion of the housing;
a connection block for each of the plural components carried by the connection portion of the housing, one connection block being carried on each side of the connection portion of the housing with a side surface interfacing with a planar side portion of the mixing and dispensing element, each connection block providing means for connecting a supply of one of the plural components with the mixing chamber of the mixing and dispensing element and including an internal supply passageway leading to an outlet opening in its side surface, the side surface of each of said connection blocks carrying a seal element around its outlet opening that slidably engages the interfacing planar side portion of the mixing and dispensing element and seals the interface between the connection block and the mixing and dispensing element;
an air-operated actuator carried by the actuator portion of the housing for sliding the mixing and dispensing element with respect to the connection portion of the housing between a rearward position at which the admission openings of the mixing and dispensing element communicate with the outlet openings of the connection blocks, permitting a flow of the plural components into the mixing chamber for mixing and dispensation, and a forward-purging position at which the outlet openings, of the connection blocks that are blocked by the planar side portions of the mixing and dispensing element, and the admission openings are located in a purge air chamber; and
a purge air inlet for compressed air and a passageway from the purge air inlet to the purge air chamber, whereby the application of compressed air to the purge air inlet is directed through the admission openings and dispensing orifice;
and further comprising a purge air control connected with a source of compressed air and connected with the purge air inlet, said purge air control being operable upon receipt of a purge control signal from the dispensing apparatus to apply a flow of compressed purge air to said purge air inlet of the dispensing apparatus after a time delay when the mixing and dispensing element has been moved by the actuator from its rearward dispensing position to is forward purging position.

9. The dispensing system of claim 8, wherein the purge air control provides an adjustable time delay.

10. The dispensing system of claim 8, wherein the purge control signal comprises a flow of compressed air from the dispensing apparatus that is used to move the mixing and dispensing element to its rearward dispensing position.

11. The dispensing system of claim 10 wherein the purge air control comprises a purge air control valve and a purge air delay timer, the compressed air purge control signal, closing the purge air control valve preventing a flow of purge air to the purge air inlet and setting the purge air control timer, the termination of the compressed air purge control signal allowing the purge air control timer to begin its timing cycle, the purge air control timer, after its timing cycle, applying compressed air to the purge air control valve, opening the purge air control valve to allow a flow of purge air to the purge air inlet and through the admission openings and dispensing orifice of the mixing and dispensing element.

12. A dispensing system for settable liquids, comprising:
a dispensing nozzle for the settable liquid including a dispensing outlet and a liquid outlet; a liquid control for controlling the flow of settable liquid through the dispensing nozzle, including means for generating a purge control signal for a purge air control; and a purge air portion for directing a flow of compressed purge air through the dispensing nozzle; and
a purge air control including a compressed air inlet, a purge air outlet, a purge control signal input, a purge air control valve connected between the compressed air inlet and purge air outlet, and an adjustable purge air delay timer, said purge air control reacting to said purge control signal to close the purge air control valve until said purge air control valve is opened by said purge air delay timer.

13. The dispensing system of claim 12, wherein said adjustable purge air delay timer may be adjusted to provide a time delay as short as about 2-3 seconds.

14. The dispensing system of claim 12, wherein the liquid control for controlling the flow of settable liquids uses compressed air to assist operator personnel.

15. The dispensing system of claim 12, wherein the liquid control includes a compressed air operable piston/cylinder actuator for operation of a liquid flow control valve, and a trigger operable by the operator personnel to control the flow of compressed air to the piston/cylinder actuator.

16. The dispensing system of claim 15, wherein the means for generating a purge control signal for the purge air control comprises a compressed air passageway connected with the compressed air used to operate the piston/cylinder actuator.
